(19) United States
(12) Patent Application Publication
(10) Pub. No.: US 2007/0017440 A1
(43) Pub. Date: Jan. 25, 2007

(54) System, apparatus and process for coating and curing disposable containers

(76) Inventors: Jiansheng Tang, Mars, PA (US); David Allen Cowan, Cranberry Township, PA (US); Dennis H. Piispanen, Beaver, PA (US)

Correspondence Address: Gary F. Matz;NOVA Chemicals Inc., Westpointe Center, 1550 Coraopolis Heights Road, Moon Township, PA, 15108, US

(21) Appl. No.: 11/482,340

(22) Filed: Jul. 7, 2006

Related U.S. Application Data
(60) Provisional application No. 60/701,861, filed on Jul. 22, 2005.

(51) Int. Cl. B05B 13/06

(52) U.S. Cl. 118/318

(57) ABSTRACT

A system, apparatus, and method for coating and curing disposable containers, e.g. cups that are made from thermoplastic particles, e.g. expandable polystyrene particles (EPS), and that are coated with a coating, e.g. latex coating. The system comprises a preparation station, a coating station, a curing station, and a container handling station. An apparatus comprising a rotatable wheel is used to position the containers into the several stations. The rotatable wheel contains a plurality of container holding means that consists of vacuum means selectively operable for retaining and releasing the containers relative to the stations and a rotatable platform for selectively rotating the containers to evenly apply and/or dry the coating on the containers and to increase the production rate for coating and/or curing the containers.

### BACKGROUND OF THE INVENTION

1. Field of the Invention

The present invention relates to disposable containers. More particularly, the present invention relates to a system, an apparatus, and a process for coating and curing molded foam disposable containers that are made from thermoplastic particles and that are coated with a coating, e.g. latex coating. The containers may be used to hold liquids or foods that may contain oil and/or fatty components, e.g. precooked fat-containing foods, e.g. instant noodles, soups, fried chicken, and sauces.

2. Background Art

The manufacture of molded foam containers, e.g. cups, bowls, etc. from thermoplastic particles is well known. The most commonly used thermoplastic particles are expandable polystyrene (EPS) particles.

Typically, polystyrene beads or particles are impregnated with hydrocarbon, e.g. pentane as a blowing agent that boils below the softening point of the polystyrene and causes the particles to expand when heated.

The formation of molded containers from impregnated polystyrene particles is generally done in two steps. First, the impregnated particles are pre-expanded to a density of from about 2 to 12 pounds per cubic foot. Second, the pre-expanded particles are heated in a closed mold to further expand the pre-expanded particles to fuse the beads together to form a foam article, e.g. containers, e.g. cups, bowls, having the shape of the mold.

The expandable polystyrene particles used to make foam containers are generally prepared by an aqueous suspension polymerization process, which results in particles that can be screened to relatively precise particle sizes. Typically, the raw particle diameters for making containers, such as cups, range from about 0.008 to about 0.02 inch. It has been known to produce cups from beads having a diameter of about 0.03 inches.

In spite of careful bead size control, one problem that continues to plague the container industry is that after a period of time the containers, especially those made from EPS particles, have a tendency to leak. That is, liquids, especially hot liquids, e.g. coffee, water, oil and/or fat, permeate around the fused polystyrene beads and leak onto the outer surface of the container. Generally, this results in an unsafe situation for the person holding the container and/or results in stains appearing on the outer surface of the container. It is known that leakage resistance is dependent on temperature. That is, hot liquid and food substances tend to penetrate around the fused beads faster than cold substances.

Several approaches have evolved over the years in an attempt to reduce leakage in containers that retain cold or hot liquids and/or pre-cooked foods. One such approach is by coating the sidewalls of the containers, as disclosed, for example in U.S. patent application having U.S. Ser. No. 11/014,648 filed Dec. 16, 2004 entitled “Disposable Containers Coated with a Latex Coating”, wherein the container is preferably made from expandable thermoplastic particles, e.g. expandable polystyrene (EPS) particles.

Many devices are known for applying a coating onto a substrate. For example, U.S. patent application 2004/0234698 A1 published on Nov. 25, 2004 and entitled “Method and Apparatus for Mixing and Applying a Multi-component Coating Composition” discloses a system for applying a multi-component coating over an automotive substrate. The coating device is a pneumatic, siphon-feed coating gun.

U.S. patent application 2004/0071885 A1 published on Apr. 15, 2004 and entitled “Dip, Spray, and Flow Coating Process for Forming Coated Articles” discloses an apparatus and method for making coated containers, preferably comprising polyethylene terephthalate, from coated pre-forms made by blow molding. The coating is comprised of an aqueous dispersion of a thermoplastic epoxy resin. The method includes drying/curing the coating. The coating and drying may be applied in more than one pass such that the coating properties are increased with each coating layer.

U.S. patent application 2004/0028818 A1 published on Feb. 12, 2004 and entitled “Systems and Methods for the Deposition and Curing of Coating Compositions” discloses a coating system coupled to a plurality of materials that are suitable for forming a coating layer on a surface of one or more substrates. A suitable spraying system may include a spray nozzle or gun of any type, such as an air, airless, thermal, ultrasonic, or hydraulic force spray nozzle or gun. A suitable curing source includes a heating device, a radiation device, a microwave device, a plasma device and combinations thereof. For example it may be desirable to combine radiative thermal energy with UV radiation or IR radiation to cure the coatings. The substrate may be a tape, film, web or roll.

U.S. Pat. No. 4,206,249 issued Jun. 3, 1980 discloses a process for producing a paper container having high impermeability to liquid. The teachings involve spray coating a polymerizable solution containing a pre-polymer onto a wall surface of the paper container and irradiating the coated wall with ultraviolet light to set the pre-polymer onto the wall surface thereof. This forms a coating that is impermeable to liquids, such as water, milk, soft drinks, oils, etc. This patent teaches in column 2, lines 45-62, a method in which the interior wall surface of the container is lined with a thermoplastic film. The thermoplastic film is first laminated onto a blank and the blank is formed into a container. Spray coating of the polymerizable solution onto the container wall has to be conducted by hot melt airless spraying since conventional air spraying or airless spraying is not suitable. The hot melt airless spraying device may be that manufactured and sold by Nordson Corporation U.S.A.

The prior art does not disclose a system, including an apparatus and a process, for coating and curing containers made of thermoplastic resins, e.g. expandable polystyrene, and which containers are used to hold liquids and foods, e.g. coffee, soups, stews, pre-cooked foods, and sauces.

### SUMMARY OF THE INVENTION

The invention has met the above need.

A system for coating and curing a container comprises: a preparation station for retaining the container; spraying means including nozzle means for applying a coating layer onto a wall of the container; curing means for drying the coating layer on the wall of the container; and positioning means for positioning the container in sequential fashion from the preparation means to the spraying means and from the spraying means to the curing means.

A process for coating and curing a container comprises: a) retaining the container in a preparation station; b) applying a coating layer onto a wall of the container, c) drying said coating layer on the wall of the container; and d) sequentially positioning the container for steps b) and c).

An apparatus for coating and curing a container comprises: spraying means for applying a coating on a wall of the container; curing means for drying the coating on the wall of the container; rotatable means comprising retaining means for holding the container; and control means for sequentially positioning the container adjacent the spraying means and the curing means. The retaining means is preferably used in conjunction with a container preparation station and includes vacuum means for grasping the container from the preparation station and spinning means for rotating the container along its longitudinal axis so as to apply a consistent layer of coating onto the wall of the container. Preferably, the coating layer is applied onto an inner wall of the container.

Some embodiments of the invention include rotatable means located relative to the curing means such that a portion of the rotatable means carrying the container enters into the curing means and whereby the container is conveyed from the preparation station to the spraying means and into the curing means.

Some embodiments of the invention include rotatable means rotated such that the container is 1) conveyed from the preparation station to the spraying means; 2) conveyed from the spraying means to a pre-drying means; 3) conveyed from the pre-drying means onto conveyer means; and 4) conveyed by the conveyer means to the curing means for drying and setting the coating on the wall of the container.

Some embodiments of the invention include a handling system, which carries the container away from the coating and curing system for packaging and/or bagging of the containers for shipping and/or storage purposes.

The container may be formed in a steam mold from expandable thermoplastic particles and a coating, such as the latex coating disclosed in the aforesaid U.S. Ser. No. 11/014,648 filed Dec. 16, 2004 entitled “Disposable Containers Coated with a Latex Coating”, may be applied to at least a portion of the surface of the container. The container is relatively impenetrable thereby substantially reducing or eliminating leakage, and stains from forming on the surfaces of the container.

If the coating is a latex coating, then the latex coating may be selected from the group consisting of latex of methyl methacrylate and styrene copolymer, latex of methyl acrylate and styrene copolymer, latex of acrylic acid and styrene copolymer, and latex of butadiene and styrene copolymer.

The thickness of the coating may range from about 0.10 mils (0.27 mg dry coating weight per square centimeter cup surface) to about 5.0 mils (13.4 mg dry coating weight per square centimeter cup surface), and preferably may be about 0.9 mils (about 0.25 mg dry coating weight per square centimeter cup surface). The coating may be applied to a portion of or to the entire inner and/or outer surfaces of the container.

The container may be made from thermoplastic resin beads, e.g. expandable thermoplastic resin beads, and in some embodiments, the expandable thermoplastic resin is expandable polystyrene (EPS).

Some embodiments of the invention involve a molded thermoplastic container that exhibits improved resistance to leakage and/or stain and improved insulation properties.

Some embodiments of the invention involve a coating that is applied to the inner and/or outer surface of a molded thermoplastic container.

Other embodiments of the invention involve a method for applying a coating onto a surface of a molded thermoplastic container and drying the coating.

And still other embodiments involve a system for applying a coating, curing the coating, and conveying the container to a container packaging/bagging system.

And still other embodiments of the invention involve a system and method for improving the production rate for curing and coating containers.

These and other aspects of the invention will be more fully appreciated and understood from the following description and the appended claims.

### BRIEF DESCRIPTION OF THE DRAWINGS

FIG. 1 is a schematic elevational view illustrating a first embodiment of the spraying and curing system and apparatus of the invention.

FIG. 2 is a schematic elevational view illustrating a second embodiment of the spraying and curing system and apparatus of the invention.

### DETAILED DESCRIPTION OF THE INVENTION

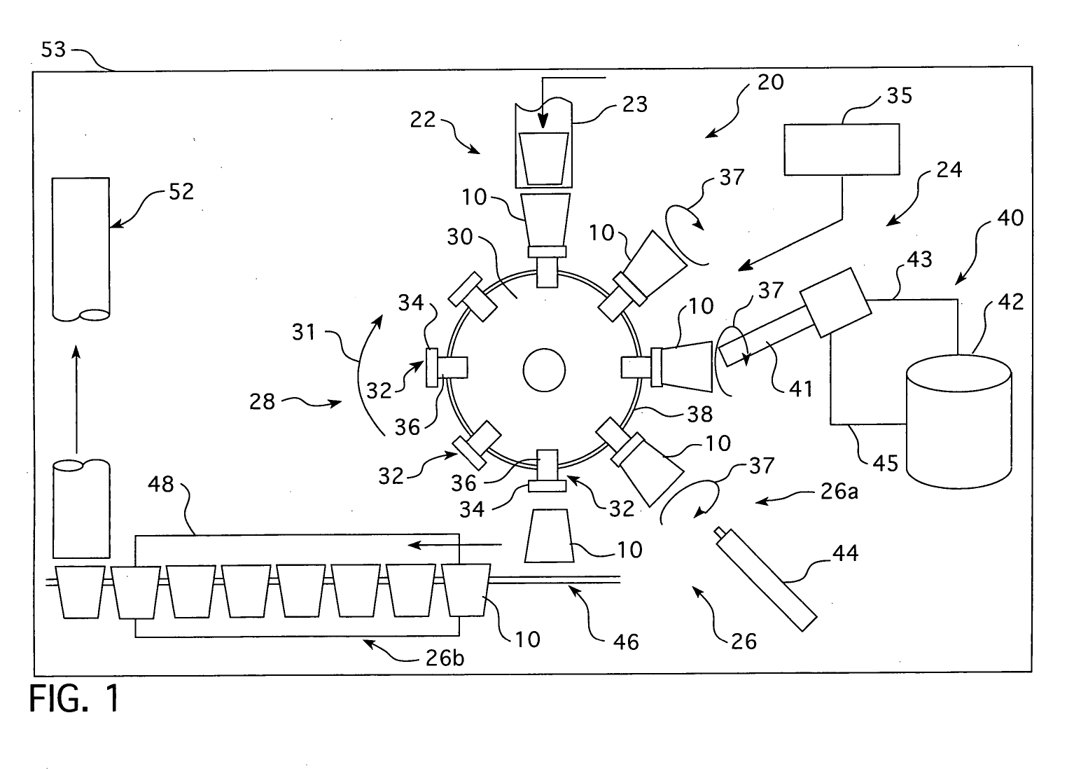

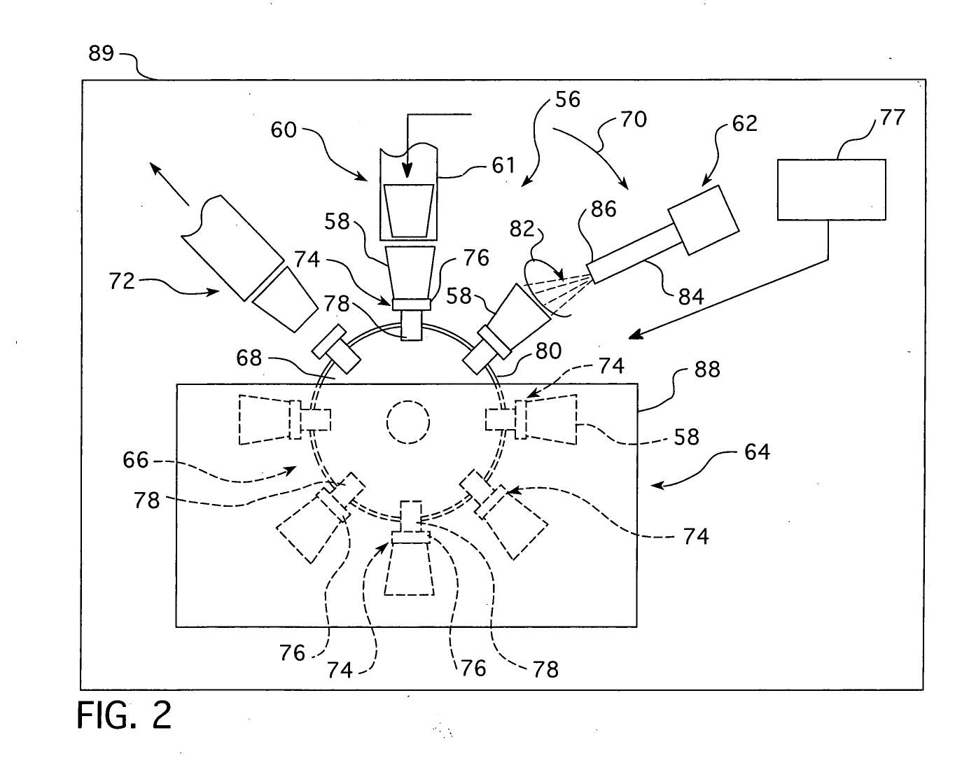

In FIGS. 1 and 2, containers 10, e.g., cups, bowls, and the like are molded from thermoplastic particles, which may be expandable thermoplastic particles, made from any suitable thermoplastic homopolymer or copolymer.

Particularly suitable for use are homopolymers derived from vinyl aromatic monomers including styrene, isopropylstyrene, alpha-methylstyrene, nuclear methylstyrenes, chlorostyrene, tert-butylstyrene, and the like, as well as copolymers prepared by the copolymerization of at least one vinyl aromatic monomer with monomers such as divinylbenzene, butadiene, alkyl methacrylates, alkyl acrylates, acrylonitrile, and maleic anhydride, wherein the vinyl aromatic monomer is present in at least 50% by weight of the copolymer.

Styrenic polymers are preferred, particularly polystyrene. However, other suitable polymers may be used, such as polyolefins (e.g. polyethylene, polypropylene), and polycarbonates, polyphenylene oxides, and mixtures thereof. If the thermoplastic particles are expandable than preferably they are expandable polystyrene (EPS) particles.

The particles may be in the form of beads, granules, or other particles convenient for expansion and molding operations. Particles polymerized in an aqueous suspension process are essentially spherical and are preferred for molding the foam container of the invention. The particles are screened so that their diameter ranges from about 0.008 to about 0.02 inch.

Expandable thermoplastic particles are impregnated with a suitable blowing agent using any conventional method. For example, the impregnation can be achieved by adding the blowing agent to the aqueous suspension during the polymerization of the polymer, or alternatively by re-suspending the polymer particles in an aqueous medium and then incorporating the blowing agent as taught in U.S. Pat. No. 2,983,692 to D. Alelio.

Any gaseous material or material which will produce gases on heating can be used as the blowing agent. Conventional blowing agents include aliphatic hydrocarbons containing 4 to 6 carbon atoms in the molecule, such as butanes, pentanes, hexanes, and the halogenated hydrocarbons, e.g. CFC's and HCFC'S, which boil at a temperature below the softening point of the chosen polymer. Mixtures of the aliphatic hydrocarbons blowing agents can also be used.

Alternatively, water can be blended with these aliphatic hydrocarbons blowing agents or water can be used as the sole blowing agent as taught in U.S. Pat. Nos. 6,127,439; 6,160,027; and 6,242,540 assigned to NOVA Chemicals (International) S.A. In the aforesaid patents, water-retaining agents are used. The weight percentage of water for use as the blowing agent can range from 1 to 20%. The teachings of U.S. Pat. Nos. 6,127,439, 6,160,027 and 6,242,540 in their entirety are incorporated herein by reference.

The impregnated thermoplastic particles are generally pre-expanded to a density of from about 2 to about 12 pounds per cubic foot. The pre-expansion step is conventionally carried out by heating the impregnated beads via any conventional heating medium, such as steam, hot air, hot water, or radiant heat. One generally accepted method for pre-expanding impregnated thermoplastic particles is taught in U.S. Pat. Ser. No. 3,023,175 to Rodman.

The impregnated thermoplastic particles can be foamed cellular polymer particles as taught in Arch et al. U.S. patent application Ser. No. 10/021,716 assigned to NOVA Chemicals Inc, the teachings of which in their entirety are incorporated herein by reference. The foamed cellular particles are preferably polystyrene that are pre-expanded to a density of from about 12.5 to about 34.3 pounds per cubic foot, and that contain a volatile blowing agent level less than 6.0 weight percent, preferably from about 2.0 wt % to about 5.0 wt %, and more preferably ranging from about 2.5 wt % to about 3.5 wt % based on the weight of the polymer.

In a conventional manner, the pre-expanded particles (“pre-puff”) are heated in a closed mold to further expand the particles and to form the foam molded container of the invention.

FIG. 1 illustrates a system 20 for coating and curing containers 10, which, as shown, are cups. System 20 comprises preparation station 22, container dispensing mechanism 23, coating station 24, curing station 26 that is comprised of pre-drying station 26a and drying station 26b, and rotatable apparatus 28 that retains and conveys cups 10 through the several stations and operations of system 20, more about which will be discussed herein.

Still referring to FIG. 1, rotatable apparatus 28 comprises rotatable wheel 30 that rotates on its horizontal axis in a clockwise direction as indicated by arrow 31 shown to the left of wheel 30 to bring cups 10 into communication with coating station 24 and curing station 26. Rotatable wheel 30 contains a plurality of container holding means around its outer periphery, some of which are indicated at 32. Each container holding means 32 is comprised of rotary platform 34, which is mounted via pin 36 into the external surface 38 of rotatable wheel 30.

Rotary platform 34 is preferably of the same shape as the bottom of cups 10, e.g. in FIG. 1, the bottom of cups 10 are circular, and may be relatively the same diameter or size as the bottom of cups 10. Also, each rotary platform 34 contains vacuum means, one indicated schematically at 35 in FIG. 1, which is selectively operable to apply suction when rotary platform 34 is positioned adjacent preparation station 22 in order to retain cup 10 after cup 10 falls by gravity from dispensing mechanism 23 onto platform 34 of container holding means 32, and to discontinue such to release cup 10 in the drying station 26b, more about which will be discussed herein.

Each rotary platform 34 is constructed and arranged to rotate or spin in a clockwise direction as shown by arrows 37. Each platform 34 will rotate at approximately 23 revolutions per second. This rotation of rotary platform 34 will be synchronized with the rotation of wheel 30 such that cups 10 are brought into communication with coating station 24 so that an even layer of coating may be applied onto the inner surface wall of cups 10. The placing of this layer of coating onto the inner surface wall of cups 10 will take approximately 0.15 seconds.

The thickness of this coating on inner surface of cups 10 may range from about 0.10 mils (0.27 mg dry coating weight per square centimeter cup surface) to about 5.0 mils (13.4 mg dry coating weight per square centimeter cup surface), and preferably may be about 0.9 mils (about 2.5 mg dry coating weight per square centimeter cup surface). The coating may be applied to a portion of or to the entire inner wall of cups 10. Preferably, in the embodiment of FIG. 1, the coating is applied to the entire inner wall surface of cups 10.

Coating station 24 is comprised of a spraying system 40 having nozzle 41 that applies a coating onto the inner surface of cup 10, and a reservoir tank 42 for holding the coating. Reservoir tank 42 has inlet conduit 43 and outlet conduit 45, shown schematically in FIG. 1. Inlet conduit 43 delivers the coating to spray nozzle 41, and outlet conduit 45 returns the coating to reservoir tank 42 during the coating cycle of consecutive cups 10 upon their rotation around the outer periphery of wheel 30 and into and out of the immediate vicinity of coating station 24. Spray nozzle 41 is shown in FIG. 1 as directing its spray into cup 10. However, additional spray nozzles may be provided wherein a coating may be applied onto the outer surface wall of container 10, or nozzle 41 may be positioned to direct its spray onto the outer wall of cup 10.

Spray nozzle means 40 may be an airless spraying device available from Nordson Corporation. An example of such spraying device provided by Nordson Corporation is disclosed in the aforesaid Suzuki et al., U.S. Pat. No. 4,206,249. In this instance, it is preferable that the airless spraying device applies the coating at room temperature instead of at the elevated temperatures taught in U.S. Pat. No. 4,206,249. It is understood that minor modifications can be made to the spraying device of the '249 patent when spraying the coating in accordance with the teachings of the invention.

The coating rate may be defined as “the dry weight of the coating sprayed onto the unit surface area of the container”. As stated herein, the coating rate may range from about 0.27 milligrams to about 13.4 milligrams dry coating weight per square centimeter cup surface. The greater the coating rate, the thicker the coating layer, the better the stain resistance, and the longer the drying time for the coating on the wall surface of cup 10.

Still referring to FIG. 1, curing station 26 is comprised of a pre-drying station 26a and drying station 26b. Pre-drying station 26a is comprised of a hot air gun 44 that directs a stream of hot air onto the inner wall of cups 10 to pre-dry the coating layer, and drying station 26b is comprised of conveyor belt means 46 and drying chamber 48 shown toward the bottom portion of FIG. 1. Here again, if a coating is applied to the outer wall of container 10, then hot air gun 44 may be positioned to pre-dry this outer wall coating. Also, more than one hot air gun may be provided.

Hot air gun 44 may be of the type available from the Leister Company under the name Hotwind S Hot Air Blower, which operates to direct a stream of hot air at a temperature range of ambient to about 80° C., preferably 90° C., onto the surface walls of cups 10 as cups 10 continue to spin in a clockwise direction indicated by arrow 37. The stream of hot air pre-dries or pre-sets the coating applied onto the wall surface of cups 10 prior to cups 10 being conveyed onto conveyor belt means 46 and into drying chamber 48.

Drying chamber 48 may be operated at atmospheric pressure and a temperature ranging from about 70° C. to about 199° C., preferably from about 85° C. to about 95° C., and most preferably at 90° C. for a time ranging from about 30 seconds to about 90 seconds. Preferably cups 10 are conveyed through chamber 48 for about 45 seconds to about 70 seconds.

At drying station 26b, the vacuum means 35 of platform 34 of container holding means 32 is shut off so as to release cups 10 so that they can free fall onto conveyor belt means 46 shown toward the lower portion of FIG. 1. Even though not shown, conveyor belt means 46 preferably is comprised of two horizontally spaced-apart belts that travel at the same speed. As cups 10 are released from wheel 30 and onto conveyor belt means 46, cups 10 will tend to pivot upwardly such that the mouth of cups 10 will point upwardly and in this position, the cups 10, by gravity, will free fall between the two spaced-apart belts such the rim of cups 10 are supported by the two spaced-apart belts which in turn conveys cups 10 through drying chamber 48.

From drying chamber 48, the cups are then conveyed via container handling station 52. Container handling system 52 may comprise a conveyer belt for conveying cups 10 to the packaging line.

Rotatable wheel 30 is rotated and indexed into preparation station 22, coating station 24, curing station 26 and container handling station 52 in a sequential manner to coat and dry cups 10. This positioning will be performed in conjunction with the operation of the vacuum means 35 of each container holder means 32 and the rotation of platform 34 of each container holding means. A control means 53 for accomplishing this will be comprised of devices known in the art, which will be automatically operated through suitable electrical means or programmable means known to those skilled in the art.

The manner for conveying a single cup 10 through the system of FIG. 1 by control means indicated at 53 generally will consists of the following:

In Preparation Station 26:

Rotatable wheel 30 is stopped so that container holding means 32 is indexed in alignment with cup dispensing means 23. The vacuum means 35 in platform 34 of this respective container holding means 32 is activated, and dispensing mechanism 23 releases cup 10. Dispensing mechanism 23, controlled by photosensitive means (not shown), is activated when it senses container-holding means 32. At some location immediately before the spraying station 24, platform 34 is activated to rotate cup 10 in the direction shown by arrow 37.

In Coating Station 24:

While platform 34 and cup 10 are rotating, spray nozzle 40 is operated via photosensitive means (not shown) to apply a coating onto the surface of cup 10. The spraying period is pre-set, for example, about 0.15 seconds, as stated herein above. The duration of the container holding means 32 with cup 10 in this station should not be less than the spraying time.

In Re-drying Station 26a:

Wheel 30 is rotated to bring a container holding means 32 into pre-drying station 26a. As rotary platform 32 continues to rotate, hot air gun 44 is automatically operated via photosensitive means (not shown) and timed to direct a stream of dry air into cup 10. Even though one hot air gun 44 is shown in FIG. 1, it is to be understood that several such air guns 44 may be arranged around wheel 30, if necessary.

In Drying Station 26b:

Wheel 30 is rotated to index cup 10 directly above conveyor belt means 46. At this time, both the rotation of rotary platform 34 and the operation of vacuum means 35 are discontinued and cup 10 is released onto conveyor belt means 46, which conveys cup 10 through curing chamber 48.

FIG. 2 illustrates a further embodiment of the invention. FIG. 2 illustrates system 56 for coating and curing containers 58, which, as shown, are cups. System 56 comprises preparation station 60, container dispensing mechanism 61, coating station 62, curing station 64, and rotatable apparatus 66, that retains and conveys cups 58 through the several stations and operations of system 56, in a manner similar to system 20 of FIG. 1.

Rotatable apparatus 66 comprises rotatable wheel 68 that rotates on its horizontal axis in a clockwise direction as indicated by arrow 70 shown to the upper right of wheel 68 of FIG. 2 to bring cups 58 into communication with coating station 62, curing station 64, and cup handling station 72. Wheel 68 contains a plurality of container holding means 74 around its outer periphery. Each container holding means 74 is comprised of a rotary platform 76, which is mounted via pin 78 into the external surface 80 of wheel 68.

Rotary platform 76 is preferably of the same shape as the bottom of cups 58, e.g. in this instance, circular, and may be relatively the same diameter or size as the bottom of cups 58. Also, each platform 76 contains vacuum means 77, one shown schematically in FIG. 2, which is selectively operable to apply suction when container holding means 74 is located adjacent to preparation station 60 in order to retain cups 58 after they fall by gravity from container dispensing mechanism 61 onto rotary platform 76 and to discontinue suction in order to release cup 58 when it approaches cup handling station 72, more about which is discussed herein below.

Each rotary platform 76 is constructed and arranged to rotate in a clockwise direction as shown by arrow 82. Each platform 76 will rotate at approximately 23 revolutions per second. This rotation of platform 76 will be synchronized with the rotation of wheel 68 such that cups 58 are brought into communication with coating station 62, which applies an even layer of coating onto the inner surface of cups 58. The applying of this layer of coating onto the inner surface of cups 58 will take approximately 0.15 seconds.

The thickness of this coating on inner surface of cups 58 may range from about 0.10 mils (0.27 mg dry coating weight per square centimeter cup surface) to about 5.0 mils (13.4 mg dry coating weight per square centimeter cup surface), and preferably may be about 0.9 mils (about 0.25 mg dry coating weight per square centimeter cup surface). The coating may be applied to a portion of or to the entire inner surface of cups 58. Preferably, the coating is applied to the entire inner surface of cups 58.

Coating station 62 is comprised of a spraying system 84 having nozzle 86 that applies a coating onto the inner surface of cups 58. Even though not shown in FIG. 2, spraying system 84 may comprise a reservoir tank similar to that shown in the embodiment of FIG. 1.

Spraying system 84 preferably is an airless spraying device available from Nordson Corporation similar to that taught herein for the embodiment of FIG. 2. Also, the coating rate for spraying system 84 will be similar to that of spraying system 40 of FIG. 1.

Still referring to FIG. 2, curing station 64 is comprised of drying means 88 in which wheel 68 rotates and carries cups 58 into and out of drying means 88. Drying means 88 may be of a custom made oven, which supplies hot air at a temperature range of about 90° C. to cups 58 to dry and/or cure the coating layer on cups 58. Cups 58 are rotated out of drying means 88 and conveyed via suction into cup handling station 72.

Preferably drying means 88 operates at atmospheric pressure and at a temperature range of from about 70° C. to about 199° C., preferably from about 85° C. to about 95° C., and most preferably at 90° C. for a time ranging from about 45 seconds to about 70 seconds. Preferably cups 58 are conveyed through drying means 88 for a time ranging from about 45 seconds to about 70 seconds.

As each container holding means 74 approaches container handling station 72, the vacuum supply in platform 76 of container holding means 74 is discontinued to allow cups 58 to be released from wheel 68 and taken up into container handling station 72, which, in turn, carries cups 58 away from the coating and curing system 56 of the invention to a further processing station, such as, for example, a container packaging station.

Wheel 68 is rotated and indexed into preparation station 60, coating station 62, curing station 64 and container handling station 72 in a sequential order for the coating and curing of cups 58. This positioning of cups 58 will be done via a control means indicated at 89 in conjunction with the operation of the vacuum means in each container holding means 74 and rotation of platform 76 of each container holding means 74 in a manner similar to that of FIG. 1. The control means 89 for accomplishing this may be similar to that taught for the embodiment of FIG. 1.

The manner for conveying a single cup 58 through the system of FIG. 2 by control means 89 generally will consists of the following:

In Preparation Station 60:

Wheel 68 stops rotating so that a container holding means 74 is indexed in alignment with container dispensing means 61. The vacuum in rotary platform 76 of this respective container holding means is activated, and dispensing mechanism 61 releases a cup 58. Dispensing mechanism 61, controlled by a photosensitive means (not shown), is activated when it senses the container holding means 74. At some location immediately before the spraying station 62, rotary platform 76 is activated to rotate cup 58 in the direction shown by arrow 82.

In Coating Station 62:

While rotary platform 76 and cup 58 are rotating, spraying system 84 is operated via photosensitive means (not shown) to apply a layer of coating onto the inner surface of cup 58. The spraying time is pre-set to a predetermined time, for example, about 0.15 seconds. The duration of the rotary platform 76 with cup 58 in this station should not be less than the spraying time.

In Curing Station 64:

Wheel 68 is rotated to bring rotary platform 76 into curing station 64. At this time, rotary platform with cup 58 discontinues rotation, while wheel 68 rotates to index rotary platform and cup 58 into cup handling station 72.

In the embodiments of FIGS. 1 and 2, the production rate for spraying system 24, 62 for applying a coating onto the inner surface of cups 10, 58 which may be 16-ounce cups may range from about 50 to about 600 cups per minute. It is apparent that several spraying systems may be used to accommodate the desired production rate of the cups.

In the invention, any suitable coating compositions may be applied to cups 10 and 58. However, if a latex coating composition is to be applied, then this coating may be similar to that disclosed in the aforesaid U.S. Ser. No. 11/014,648 filed Dec. 16, 2004 entitled “Disposable Containers Coated with a Latex Coating”, wherein the container is preferably made from expandable thermoplastic particles, e.g. expandable polystyrene (EPS) particles, which reference, is incorporated herein in its entirety.

In this instance, the latex coating composition may be of the type that will not be detrimental to the thermoplastic particles forming the container. That is, the latex coating used in the invention will be devoid of any chemicals that tend to dissolve or react with the thermoplastic particles, particularly polystyrene particles. For example, most solvent-based polymeric coatings would not be feasible in the invention. “Latex” can be defined as a colloidal dispersion of polymer particles in an aqueous medium, such as water. The phase ratio (polymer phase to aqueous phase) may range from 40:60 to 60:40 by weight. In the latex coating industry, a more common term is “solids content”. “Solids content” as used herein refers to the dry matter that comprises the polymer, emulsifiers, inorganic salts, etc. in the latex coating. A typical range for the solids content is between 40 and 60 percent weight. This measurement is derived by drying a latex coating sample to a constant mass at a temperature between 100 and 140° C. The solids content is then expressed as the percentage ratio of the dry matter to the total mass of the sample.

The latex used in the invention may contain surfactants and/or other minor components. The surfactant, which generally is used for stability purposes, may be any of the commonly known surfactants used in latex coatings such as sodium octyl sulfonate, sodium decyl sulfonate, sodium dodecyl sulfonate, sodium tetradecyl sulfate, sodium hexadecyl sulfate, sodium dodecyl sulfate, branched sodium alkyl sulfate, sodium dodecyl ethoxylate (2EO), dodecyl alcohol ethoxylate (5EO), dodecyl alcohol ethoxylate (7EO), dodecyl alcohol ethoxylate (8EO), etc.

A particularly suitable polymer of the latex coating used in the invention may be a homopolymer of a monomer selected from the group consisting of butadiene, n-butyl acrylate, i-butyl acrylate, 2-ethylhexyl acrylate, methyl acrylate, ethyl acrylate, octyl acrylate, vinyl acetate, vinyl chloride, vinylidene chloride, vinyl pivalate, vinyl neo-decanoate, acrylonitrile, methyl acrylonitrile, acrylamide, styrene, a-methyl styrene, methyl methacrylate, ethyl methacrylate, n-butyl methacrylate, i-butyl methacrylate; or the copolymer of two or more of the above monomers or the copolymer of two or more of the above monomers with the following functional monomers including acrylic acid, methacrylic acid, itaconic acid, fumaric acid, hydroxyethyl acrylate, hydroxyethyl methacrylate, diethylaminoethyl methacrylate, tert-butylaminoethyl methacrylate, acrylamide, dimethyl meta-isopropenyl benzyl isocyanate, N-methylolacrylamide, N-methylol methacrylamide, N-(iso-butoxymethyl)acrylamide, glycidyl acrylate, glycidyl methacrylate, sodium styrene sulfonate.

The latex coating may be comprised of a polymer of a monomer selected from the group consisting of acrylate, e.g. ethyl acrylate, methacrylate, e.g. methyl methacrylate, acrylic acid, e.g. methacrylic acid, or the copolymers of these monomers copolymerized with vinyl acetate or styrene.

Preferred latex coatings are latex of methyl methacrylate and styrene copolymer, latex of methyl acrylate and styrene copolymer, latex of acrylic acid and styrene copolymer, and latex of butadiene and styrene copolymer.

The molecular weight for the latex coating may range from about 100 to about 1 million units (500 to about 200 million g/mol). The molecular poly-dispersity for the latex coating may be defined as ranging from very narrow to very broad, i.e. from about 1.0 to about 20.

The type of latex coating particularly suitable for use in the invention is comprised of polymers in solid particulate form and water. The initial solids content of the polymer may be about 48% to about 50% by weight, which can be adjusted to change the viscosity so that the process equipment, such as the spraying system, can adequately handle the application of the coating onto the container.

The solids content of the latex prior to being applied to the container's surface generally will depend on the process being used to apply the latex to the container. In the invention, it is preferable that a spraying process be used to apply the coating onto the containers. In this instance the solid contents will range from about 40% to about 47% by weight, based on the weight of the latex.

Cups 10, 58 may be thermoplastic containers, e.g. polystyrene cups that are fabricated by a conventional cup-forming machine that has an inner shell and an outer shell. A conventional cup-forming machine is Cup Production MODEL 6-VLC-125 machine, made by Autonational B.V. or is MODEL M10 cup machine, made by Master Machine & Tool Co.

According to the teachings of the invention, after cups 10, 58 are formed, they are, through suitable means, brought into the preparation stations 22, 60 respectively of coating and curing systems 20, 56 of the invention of FIGS. 1 and 2 wherein as shown in these FIGS. 1 and 2, the coating is evenly applied to the inner surface of cups 10, 58. It is to be appreciated, that in some instances, it may be preferable to apply the coating to both the inner surface and outer surfaces of cups 10, 58. Also, preferably, the coating is applied substantially onto the entire surfaces of cups 10, 58; however, in some instances, it may preferable to apply the coating to a portion of the cups' surfaces.

In FIG. 1, after the coating is applied to the surface or surfaces of the cups 10, cups 10 are then carried via conveyor belts means 46 to curing chamber 48 which may be a drying chamber or oven. In FIG. 2, after the coating is applied to cups 58, the cups are rotated into curing chamber 88, which may be a drying chamber or oven. This oven may be a conventional oven and the heating medium may be hot air, radiant heat, or heat plus vacuum. A typical drying oven is obtained from Blue M Electric Company, Blue Island, Illinois. The drying time is dependent on the drying temperature, the solids content of the coating, and the coating thickness. For example if the coating is 1.5 mils, the drying temperature will be about 90° C. with a drying time of about 60 seconds. Typically, the drying temperature will range from about 50° C. to about 100° C. and the drying time will range from about 5 seconds to about 3000 seconds for coatings with a solids content ranging from about 8% to about 47% by weight. Curing chambers may also be a radiation device, a microwave device, a plasma device or combinations thereof.

As stated herein, the thickness of the coating, which may be a latex coating, on the surface or surfaces of the cups 10, 58 of FIGS. 1 and 2 may range from about 0.10 mils (0.27 mg dry coating weight per square centimeter cup surface) to about 5.0 mils (13.4 mg dry coating weight per square centimeter cup surface), and preferably may be about 0.9 mils (0.25 mg dry coating weight per square centimeter cup surface). This coating thickness may extend on a portion of or substantially on the entire inner and/or outer surface of the container.

The coating is applied to a portion of or substantially onto at least one of the inner and outer surfaces of cups 10, 58 to form a coating; preferably to the inner surface; and more preferably to both inner and outer surfaces.

The coating may be applied to the outer surface for leakage resistance purposes and/or for labeling and printing purposes. It is to be understood that cups 10, 58 have both a sidewall and a bottom section and that the “inner surface” and the “outer surface” generally will refer to both the sidewall and bottom section of cups 10, 58.

While the present invention has been particularly set forth in terms of specific embodiments thereof, it will be evident to those skilled in the art that numerous variations and details of the invention may be made without departing from the instant invention as defined in the appended claims. For instance, different types of coatings may be applied in one or more layers to one or more surfaces of cups 10, 58. Also, the containers made by made from non-expandable thermoplastic resins and the spray means may consist of several spray nozzles.

What is claimed is:

1. A system for coating and curing a disposable container having inner and outer surfaces, said system comprising:
a preparation station for retaining said container;
a coating station for applying a coating composition to a surface of said disposable container, and
a curing station located downstream from said coating station for pre-drying and curing said coating composition on said surface of said disposable container; and
positioning means for positioning said container in a sequential fashion from said preparation station to said coating station and from said coating station to said curing station.

2. The system of claim 1 further comprising a container handling station including means for carrying said container away from said system for coating and curing said disposable container for further processing.

3. The system of claim 1 wherein said coating station comprises:
a spraying system including spray nozzle means for evenly applying said coating composition onto said surface of said disposable containers.

4. The system of claim 3 wherein said spraying system further includes a reservoir tank for retaining said coating composition and in communication with said spray nozzle means for supplying said coating composition to said spray nozzle means.

5. The system of claim 2 wherein said positioning means comprises a rotatable wheel having a rotational axis, and wherein said curing station is located downstream of said positioning means and extends in a direction perpendicular to the rotatational axis of said positioning means.

6. The system of claim 2 wherein said positioning means is rotatable within said curing station.

7. The system of claim 6 wherein said container handling means is located in a radial direction relative to said positioning means and in close proximity to said container preparation station.

8. The system of claim 2 wherein said positioning system comprises a plurality of container holding means.

9. The system of claim 9 wherein each of said container holding means comprises vacuum means selectively operable to retain and release said container, and rotating means for selectively rotating said container so that said coating means is evenly distributed onto said surface of said container.

10. The system of claim 1 further comprises control means for said positioning of said container relative to said preparation station, said coating station, and said curing station in a sequential manner.

11. An apparatus for positioning a container relative to a plurality of stations, comprising:
a plurality of container holding means having vacuum means selectively operable for retaining and releasing said container, and rotating means for selectively rotating said container.

12. An apparatus of claim 11 wherein said apparatus comprises a rotatable wheel and said plurality of stations includes at least a coating station for applying a coating to at least the inner surface of said container and a curing station for curing said coating on said inner surface of said container.

13. An apparatus of claim 12 wherein said plurality of container holding means are located around the periphery of said rotatable wheel, and said apparatus further includes control means for positioning said container in communication with said coating station and said curing station.

14. A method for coating and curing a container, comprising:
a) retaining said container in a preparation station;
b) applying a layer of coating onto a surface of said container;
c) drying said layer of coating on said container;
d) sequentially positioning said container for steps b) and c).

15. A method for coating and curing a container, comprising:
a) retaining said container in a preparation station;
b) rotating said container to position said container relative to a coating station;
c) applying an even layer of coating onto a surface of said container;
d) rotating said container to position said container relative to a curing station;
e) curing said coating on said surface of said container.

16. A method of claim 15, wherein said rotating step includes a simultaneous rotation of said container relative to said coating station and said curing station and a rotation of said container relative to the axis of said container so that a layer of said coating is evenly applied onto said surface of said container.

17. A container coated according to the method of claim 15.

18. A system of claim 1 wherein said coating composition is a latex coating comprised of a homopolymer of a monomer selected from the group consisting of butadiene, n-butyl acrylate, i-butyl acrylate, 2-ethylhexyl acrylate, methyl acrylate, ethyl acrylate, octyl acrylate, vinyl acetate, vinyl chloride, vinylidene chloride, vinyl pivalate, vinyl neo-decanoate, acrylonitrile, methyl acrylonitrile, acrylamide, styrene, a-methyl styrene, methyl methacrylate, ethyl methacrylate, n-butyl methacrylate, i-butyl methacrylate.

19. A system of claim 18, wherein said latex coating is comprised of a polymer selected from the group consisting of a copolymer of two or more of said monomers, and a copolymer of two or more of said monomers with the following functional monomers including acrylic acid, methacrylic acid, itaconic acid, fumaric acid, hydroxyethyl acrylate, hydroxyethyl methacrylate, diethylaminoethyl methacrylate, tert-butylaminoethyl methacrylate, acrylamide, dimethyl meta-isopropenyl benzyl isocyanate, N-methylolacrylamide, N-methylol methacrylamide, N-(iso-butoxymethyl)acrylamide, glycidyl acrylate, glycidyl methacrylate, sodium styrene sulfonate.

20. A system of claim 18, wherein said latex coating is comprised of a polymer of a monomer selected from the group consisting of acrylate, methacrylate, acrylic acid, and copolymers of said monomers copolymerized with vinyl acetate or styrene.

21. A system of claim 20 wherein said latex coating is selected from the group consisting of latex of methyl methacrylate and styrene copolymer, latex of methyl acrylate and styrene copolymer, latex of acrylic acid and styrene copolymer, and latex of butadiene and styrene copolymer.

22. A system of claim 21 wherein said latex coating is latex of methyl acrylate and styrene copolymer.

23. A system of claim 22 wherein said latex coating has a thickness ranging from about 0.10 mils to about 5.0 mils.

24. A system of claim 21 wherein said latex coating when diluted has a solids content ranging from about 40% to about 47% by weight.

25. A system of claim 18 wherein said latex coating is comprised of a solids phase and a water phase, and wherein said solids phase is about 50% by weight based on the weight of the latex coating.

26. A method of claim 15 the steps further comprising:
applying said coating onto said inner surface of said container.

27. A method of claim 15 the steps further comprising:
applying said coating onto said outer surface of said container.

28. A method of claim 15 wherein said coating is a latex coating selected from the group consisting of latex of methyl methacrylate and styrene copolymer, latex of methyl acrylate and styrene copolymer, latex of acrylic acid and styrene copolymer, and latex of butadiene and styrene copolymer.

29. The method of claim 28 wherein said latex coating is latex of methyl acrylate and styrene copolymer.

30. The method of claim 28 wherein said latex coating is applied to said container via a spraying process.
